(19) United States
(12) Patent Application Publication
(10) Pub. No.: US 2017/0287480 A1
(43) Pub. Date: Oct. 5, 2017

(54) VOICE WAKE-UP METHOD AND DEVICE

(71) Applicant: ZTE Corporation, Shenzhen, Guangdong (CN)

(72) Inventors: Fengpeng Liu, Shenzhen (CN); Dongmei Liu, Shenzhen (CN)

(21) Appl. No.: 15/512,692

(22) PCT Filed: Apr. 13, 2015
(86) PCT No.: PCT/CN2015/076493

§ 371 Date: Mar. 20, 2017

(30) Foreign Application Priority Data
Aug. 19, 2014 (CN) 201410410717.3

(51) Int. Cl. G10L 15/22; G10L 25/51; H02J 13/00; G10L 21/02; H02J 3/14; G10L 15/08; G10L 21/0316

(52) U.S. Cl. CPC G10L 15/22; G10L 15/08; G10L 25/51; G10L 21/0316; G10L 21/0205; H02J 3/14; H02J 13/0017; G10L 2015/088; G10L 2015/223

(57) ABSTRACT

Disclosed is a terminal, comprising a microphone, a power supply switching control circuit, a data switching control circuit, a voice wake-up circuit and a voice wake-up power supply; the microphone is configured to acquire a voice signal and input the voice signal to the data switching control circuit; the power supply switching control circuit is configured to supply power for the microphone via the voice wake-up power supply when receiving a voice wake-up instruction; the data switching control circuit is configured to input the voice signal to the voice wake-up circuit when receiving the voice wake-up instruction; and the voice wake-up circuit is configured to preprocess and match the input voice signal, and execute a corresponding operation according to a matching result.

Also disclosed is a voice wake-up method.

### TECHNICAL FIELD

The present disclosure relates to voice signal processing techniques in the field of circuit design, and in particular to a wake-on-voice method and device.

### BACKGROUND

With the progress of science and technology, there are a variety of applications for a mobile terminal, such as a pedometer application, a navigation application, a health monitoring application, a wake-on-voice application and the like, among which the wake-on-voice application has become the focus of the industry. In existing wake-on-voice techniques, a separate voice recognition hardware system and a separate voice recognition software system are used.

During implementation of the present application, the applicant finds that the existing wake-on-voice techniques include at least the following disadvantages.

In the existing wake-on-voice techniques, an additional microphone is required to be dedicatedly arranged to acquire a wake-on-voice signal, and thus it is required to design an audio circuit, a specific structure and an identification (ID) mechanism for the dedicatedly arranged microphone. Therefore, it makes the design of the terminal to be complicated and costly.

### SUMMARY

In view of the above, embodiments of the disclosure are intended to provide a wake-on-voice method and device, which can implement wake-on-voice with a simple and low-cost circuit structure.

To this end, the technical solutions of the disclosure are implemented as follows.

There is provided a terminal, including a microphone, a power supply switching control circuit, a data switching control circuit, a wake-on-voice circuit and a wake-on-voice power supply,

herein the microphone is arranged to acquire a voice signal and input the voice signal to the data switching control circuit;

the power supply switching control circuit is arranged to, when receiving an wake-on-voice instruction, supply the microphone through the wake-on-voice power supply;

the data switching control circuit is arranged to, when receiving the wake-on-voice instruction, input the voice signal to the wake-on-voice circuit; and

the wake-on-voice circuit is arranged to preprocess and match the input voice signal, and perform an operation according to a matching result.

In an embodiment, the wake-on-voice circuit may include a wake-on-voice preprocessing circuit and a wake-on-voice matching circuit,

herein the wake-on-voice preprocessing circuit is arranged to preprocess the input voice signal and input the preprocessed voice signal to the wake-on-voice matching circuit; and

the wake-on-voice matching circuit is arranged to match the preprocessed voice signal and perform the operation according to the matching result.

In an embodiment, the terminal may further include a terminal main control processing circuit and a terminal main control power supply,

herein the power supply switching control circuit is further arranged to, when receiving an instruction indicating normal voice operation, supply the microphone through the terminal main control power supply;

the data switching control circuit is further arranged to, when receiving the instruction indicating normal voice operation, input the voice signal to the terminal main control processing circuit; and

the terminal main control processing circuit is arranged to process the input voice signal to perform the normal voice operation.

In an embodiment, the power supply switching control circuit may be implemented by a first switching circuit including a first switch, a first capacitor, a first reference power supply and a first signal amplifier, the first switch including a Common (COM) terminal, a Normally Open (NO) terminal, a Normally Closed (NC) terminal, a control (CTR) terminal, a power supply terminal and a ground terminal; and/or

the data switching control circuit may be implemented by a second switching circuit and a third switching circuit, herein the second switching circuit includes a second switch, a second capacitor, a second reference power supply and a second signal amplifier, the second switch including a COM terminal, an NO terminal, an NC terminal and a CTR terminal; and the third switching circuit includes a third switch, a third capacitor, a third reference power supply and a third signal amplifier, the third switch including a COM terminal, an NO terminal, an NC terminal, a CTR terminal, a power supply terminal and a ground terminal.

In an embodiment, in the first switching circuit, the COM terminal of the first switch is connected to a COM terminal of a power supply of the microphone, the NC terminal of the first switch is connected to the wake-on-voice power supply, the NO terminal of the first switch is connected to the terminal main control power supply, the CTR terminal of the first switch is connected to an output of the first signal amplifier, the power supply terminal of the first switch is connected to the first reference power supply and to an end of the first capacitor, the ground terminal of the first switch is grounded, and the other end of the first capacitor is grounded;

in the second switching circuit, the COM terminal of the second switch is connected to a P signal terminal of the microphone, the NC terminal of the second switch is connected to a P signal input of the wake-on-voice circuit, the NO terminal of the second switch is connected to a P signal input of the terminal main control processing circuit, the CTR terminal of the second switch is connected to an output of the second signal amplifier, the power supply terminal of the second switch is connected to the second reference power supply and to an end of the second capacitor, the ground terminal of the second switch is grounded, and the other end of the second capacitor is grounded;

in the third switching circuit, the COM terminal of the third switch is connected to an N signal terminal of the microphone, the NC terminal of the third switch is connected to an N signal input of the wake-on-voice circuit, the NO terminal of the third switch is connected to an N signal input of the terminal main control processing circuit, the CTR terminal of the third switch is connected to an output of the third signal amplifier, the power supply terminal of the third switch is connected to the third reference power supply and to an end of the third capacitor, the ground terminal of the third switch is grounded, and the other end of the third capacitor is grounded.

In an embodiment, the wake-on-voice preprocessing circuit may include a fourth capacitor, a fifth capacitor, a sixth capacitor, a seventh capacitor, an eighth capacitor, a ninth capacitor, a fourth signal amplifier, a fifth signal amplifier, a first low pass filter, a second low pass filter; and/or, the wake-on-voice matching circuit may include an analog-to-digital converter (ADC), a Micro Controller Unit (MCU) and a memory.

In an embodiment, in the wake-on-voice preprocessing circuit, an input of the fourth capacitor is connected to a P signal input, an output of the fourth capacitor is connected to an input of the fourth signal amplifier; an output of the fourth signal amplifier is connected to an input of the sixth capacitor; an output of the sixth capacitor is connected to an input of the first low pass filter; an output of the first low pass filter is connected to an input of the eighth capacitor; an output of the eighth capacitor is connected to an input of the wake-on-voice matching circuit; an input of the fifth capacitor is connected to an N signal input, and an output of the fifth capacitor is connected to an input of the fifth signal amplifier; an output of the fifth signal amplifier is connected to an input of the seventh capacitor; an output of the seventh capacitor is connected to an input of the second low pass filter; an output of the second low pass filter is connected to an input of the ninth capacitor; an output of the ninth capacitor is connected to the input of the wake-on-voice matching circuit;

in the wake-on-voice matching circuit, an input of the ADC is connected an output of the wake-on-voice preprocessing circuit, an output of the ADC is connected to an input of the MCU, and the memory is connected to the input of the MCU.

Based the aforementioned terminal, there is further provided a wake-on-voice method for a terminal, including:

upon reception of an wake-on-voice instruction, a microphone is supplied through a wake-on-voice power supply, and a voice signal is acquired through the microphone; and

the voice signal is preprocessed and matched, and an operation is performed according to a matching result.

In an embodiment, the step that the voice signal is preprocessed and matched, and the operation is performed according to the matching result may include:

amplification and low pass filtering is performed on the voice signal to obtain the preprocessed voice signal;

analog-to-digital conversion is performed on the preprocessed voice signal to obtain a digitalized voice signal;

the digitalized voice signal is compared with a plurality of stored voice template signals;

if a degree of matching between the digitalized voice signal and one of the stored voice template signals is greater than a matching degree threshold, the terminal is waken up;

if degrees of matching between the digitalized voice signal and all of the stored voice template signals are smaller than the matching degree threshold, the processing is ended.

In an embodiment, the method may further include:

upon reception of an instruction indicating normal voice operation, the microphone is supplied through a terminal main control power supply; and

the voice signal is acquired through the microphone, and the voice signal is processed to perform the normal voice operation.

In the wake-on-voice method and device provided by the embodiments of the disclosure, the microphone, the wake-on-voice power supply, the wake-on-voice matching circuit, the terminal main control power supply, the terminal main control processing circuit are built-in circuits of the terminal per se; with only one microphone provided in the terminal for being used in a time division multiplexing way, a wake-on-voice function and a normal voice function can both be implemented without following the existing wake-on-voice techniques in which an additional microphone is required to be dedicatedly arranged to acquire a wake-on-voice signal and thus it is required to design an audio circuit, a specific structure and an identification (ID) mechanism for the dedicatedly arranged microphone. In this way, the technical solutions according to embodiments of the disclosure can implement wake-on-voice with a simple and low-cost circuit structure.

### BRIEF DESCRIPTION OF THE DRAWINGS

FIG. 1 is a schematic structural diagram of a terminal according to an embodiment of the disclosure;

FIG. 2 is a schematic structural diagram of a power supply switching control circuit according to an embodiment of the disclosure;

FIG. 2 is a schematic structural diagram of a second switching circuit of a data switching control circuit according to an embodiment of the disclosure;

FIG. 2 is a schematic structural diagram of a third switching circuit of the data switching control circuit according to an embodiment of the disclosure;

FIG. 4 is a schematic structural diagram of a wake-on-voice preprocessing circuit according to an embodiment of the disclosure;

FIG. 5 is a schematic structural diagram of a wake-on-voice matching circuit according to an embodiment of the disclosure; and

FIG. 6 is a flow chart of a wake-on-voice method according to an embodiment of the disclosure.

### DETAILED DESCRIPTION

In an embodiment of the disclosure, upon reception of an wake-on-voice instruction, a microphone is supplied through a wake-on-voice power supply, and a voice signal is acquired through the microphone; the voice signal is preprocessed and matched, and an operation is performed according to a matching result.

Specific embodiments of the disclosure will be further elaborated below with reference to the drawings.

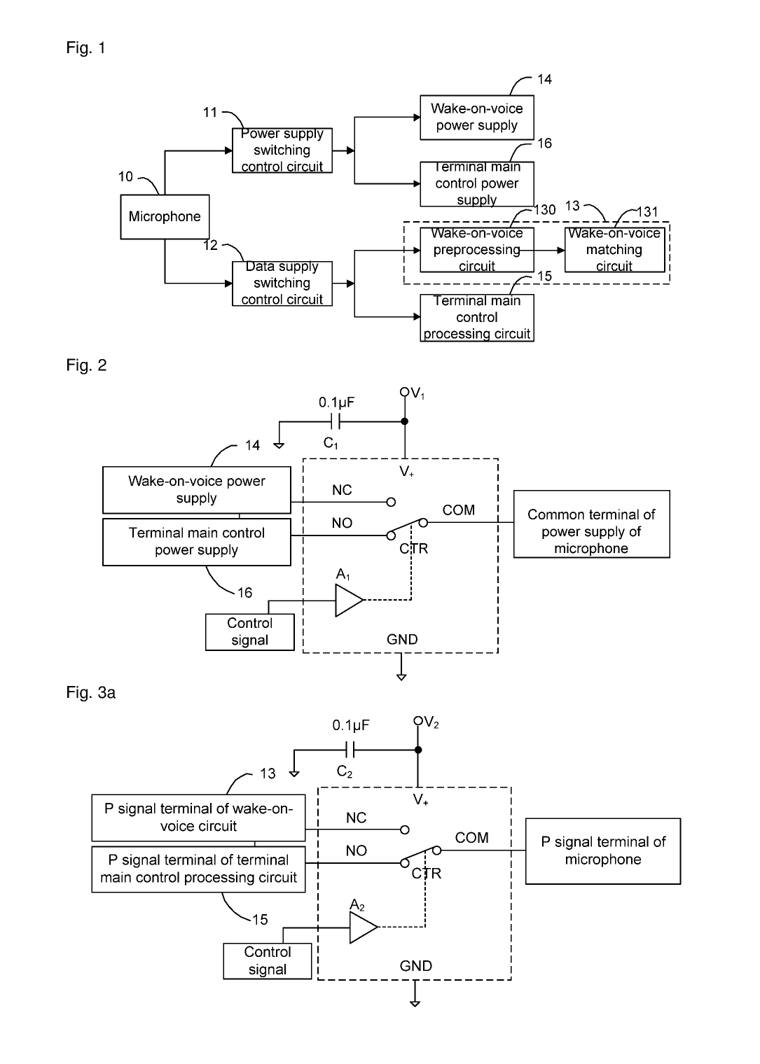

As shown in FIG. 1, an embodiment of the disclosure provides a terminal, including a microphone 10, a power supply switching control circuit 11, a data switching control circuit 12, a wake-on-voice circuit 13, and a wake-on-voice power supply 14.

The microphone 10 is arranged to acquire a voice signal and input the voice signal to the data switching control circuit 12.

The power supply switching control circuit 11 is arranged to, when receiving a wake-on-voice instruction, supply the microphone 10 through the wake-on-voice power supply 14.

The data switching control circuit 12 is arranged to, when receiving the wake-on-voice instruction, input the voice signal to the wake-on-voice circuit 13.

The wake-on-voice circuit 13 is arranged to preprocess and match the input voice signal, and perform an operation according to a matching result.

Herein, when a user activates a wake-on-voice function of the terminal, a processor of the terminal can identify an operation of the user for activating the wake-on-voice function, and the processor sends a wake-on-voice instruction to the power supply switching control circuit 11; upon reception of the wake-on-voice instruction, the power supply switching control circuit 11 determines that the terminal is in a state waiting for wake-on-voice, the microphone 10 is supplied by the wake-on-voice power supply 14, and then the microphone 10 begins acquiring a voice signal.

Specifically, the wake-on-voice circuit 13 includes a wake-on-voice preprocessing circuit 130 and a wake-on-voice matching circuit 131.

The wake-on-voice preprocessing circuit 130 is arranged to preprocess the input voice signal and input the preprocessed voice signal to the wake-on-voice matching circuit 131.

The wake-on-voice matching circuit 131 is arranged to match the preprocessed voice signal and perform the operation according to the matching result.

Further, the terminal may further include a terminal main control processing circuit 15 and a terminal main control power supply 16.

The power supply switching control circuit 11 is further arranged to, when receiving an instruction indicating normal voice operation, supply the microphone 10 through the terminal main control power supply 16.

The data switching control circuit 12 is further arranged to, when receiving the instruction indicating normal voice operation, input the voice signal to the terminal main control processing circuit 15.

The terminal main control processing circuit 15 is arranged to process the input voice signal to perform the normal voice operation.

Herein, when receiving an instruction indicating normal voice operation, the power supply switching control circuit 11 determines that the terminal is in a state for normal voice operation, the microphone 10 is supplied through the terminal main control power supply 16, and then the microphone begins acquiring the voice signal.

Herein, the state for normal voice operation generally refers to an operation state where an audio or video conversation is performed on the terminal.

Specific structure and connection between various devices of the power supply switching control circuit 11 is elaborated below with reference to FIG. 2.

As shown in FIG. 2, the power supply switching control circuit 11 is implemented by a first switching circuit including a first switch K₁ , a first capacitor C₁, a first reference power supply V₁ and a first signal amplifier A₁, the first switch K₁ including a Common (COM) terminal, a Normally Open (NO) terminal, a Normally Closed (NC) terminal, a control (CTR) terminal, a power supply terminal and a ground terminal.

The connections between devices of the first switching circuit are as follows.

The COM terminal of the first switch K₁ is connected to a COM terminal of a power supply of the microphone 10, the NC terminal of the first switch is connected to the wake-on-voice power supply 14, the NO terminal of the first switch K₁ is connected to the terminal main control power supply 16, the CTR terminal of the first switch K₁ is connected to an output of the first signal amplifier A₁, the power supply terminal of the first switch K₁ is connected to the first reference power supply V₁ and to an end of the first capacitor C₁, the ground terminal of the first switch K₁ is grounded, and the other end of the first capacitor C₁ is grounded.

Herein, switching of the NO and NC terminals of the first switch K₁ is controlled by the CTR terminal; upon reception of a wake-on-voice instruction, the CTR terminal outputs a high/low level control signal through the first signal amplifier A₁ to control the NC terminal of the first switch K₁ to connect to the COM terminal; upon reception of an instruction indicating normal voice operation, the CTR terminal outputs a low/high level control signal through the first signal amplifier A₁ to control the NO terminal of the first switch K₁ to connect to the COM terminal; in this way, switching of the power supply of the microphone is implemented. Herein, the control signal can be sent by a control device of the terminal, such as a processor and the like.

Specific structure and connection between various devices of the data switching control circuit 12 is elaborated below with reference to FIG. 3.

As shown in FIG. 3a, the data switching control circuit 12 is implemented by a second switching circuit and a third switching circuit, herein the second switching circuit includes a second switch K₂, a second capacitor C₂, a second reference power supply V₂ and a second signal amplifier A₂, the second switch K₂ including a COM terminal, an NO terminal, an NC terminal and a CTR terminal;

as shown in FIG. 3b, the third switching circuit includes a third switch K₃, a third capacitor C₃, a third reference power supply V₃ and a third signal amplifier A₃, the third switch K₃ including a COM terminal, an NO terminal, an NC terminal, a CTR terminal, a power supply terminal and a ground terminal.

The connections between devices of the second switching circuit are as follows.

The COM terminal of the second switch K₂ is connected to a P signal terminal of the microphone 10, the NC terminal of the second switch K₂ is connected to a P signal input of the wake-on-voice circuit 13, the NO terminal of the second switch K₂ is connected to a P signal input of the terminal main control processing circuit 15, the CTR terminal of the second switch K₂ is connected to an output of the second signal amplifier A₂, the power supply terminal of the second switch K₂ is connected to the second reference power supply V₂ and to an end of the second capacitor C₂, the ground terminal of the second switch K₂ is grounded, and the other end of the second capacitor C₂ is grounded.

The connections between devices of the third switching circuit are as follows.

The COM terminal of the second switch K₃ is connected to an N signal terminal of the microphone 10, the NC terminal of the second switch K₃ is connected to an N signal input of the wake-on-voice circuit 13, the NO terminal of the second switch K₃ is connected to an N signal input of the terminal main control processing circuit 15, the CTR terminal of the second switch K₃ is connected to an output of the second signal amplifier A₃, the power supply terminal of the second switch K₃ is connected to the second reference power supply V₃ and to an end of the second capacitor C₃ , the ground terminal of the second switch K₃ is grounded, and the other end of the second capacitor C₃ is grounded.

Herein, the voice signals are acquired through the P signal terminal and N signal terminal of the microphone 10, and the acquired voice signals are input respectively to the second switching circuit and the third switching circuit; the input of the wake-on-voice circuit 13 includes a P signal input and an N signal input, and the input of the terminal main control processing circuit 15 also includes a P signal input and an N signal input.

Herein, switching of the NO and NC terminals of the second switch K₂ is controlled by the CTR terminal; upon reception of a wake-on-voice instruction, the CTR terminal outputs a high/low level control signal through the first signal amplifier Ai to control the NC terminal of the second switch K₂ to connect to the COM terminal; upon reception of an instruction indicating normal voice operation, the CTR terminal outputs a low/high level control signal through the second signal amplifier A₂ to control the NO terminal of the second switch K₂ to connect to the COM terminal; in this way, control of switching of the P signal terminal of the microphone is implemented. Herein, the control signal can be sent by a control device of the terminal, such as a processor and the like.

Herein, switching of the NO and NC terminals of the third switch K₃ is controlled by the CTR terminal; upon reception of a wake-on-voice instruction, the CTR terminal outputs a high/low level control signal through the first signal amplifier Ai to control the NC terminal of the third switch K₃ to connect to the COM terminal; upon reception of an instruction indicating normal voice operation, the CTR terminal outputs a low/high level control signal through the third signal amplifier A₃ to control the NO terminal of the third switch K₃ to connect to the COM terminal; in this way, control of switching of the N signal terminal of the microphone is implemented. Herein, the control signal can be sent by a control device of the terminal, such as a processor and the like.

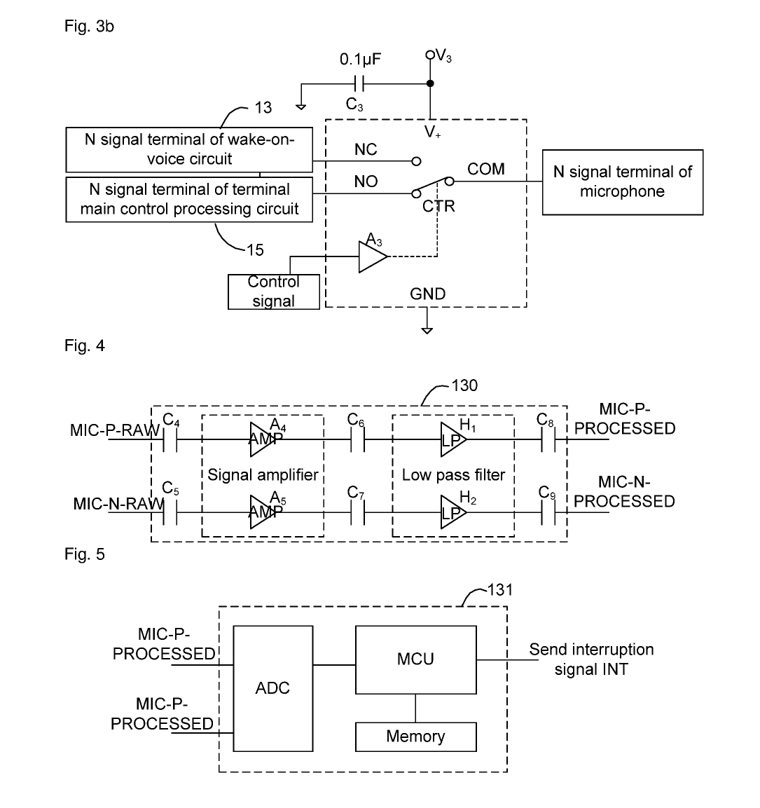

Specific structure and connection between various devices of the wake-on-voice preprocessing circuit 130 is elaborated below with reference to FIG. 4.

As shown in FIG. 4, the wake-on-voice preprocessing circuit 130 includes a fourth capacitor C₄, a fifth capacitor C₅, a sixth capacitor C₆, a seventh capacitor C₇, an eighth capacitor C₈, a ninth capacitor C₈, a fourth signal amplifier A₄, a fifth signal amplifier A₅, a first low pass filter Hi, a second low pass filter H₂.

The connections between devices of the wake-on-voice preprocessing circuit 130 are as follows.

An input of the fourth capacitor C₄ is connected to a P signal input, an output of the fourth capacitor C₄ is connected to an input of the fourth signal amplifier A₄; an output of the fourth signal amplifier A₄ is connected to an input of the sixth capacitor C₆; an output of the sixth capacitor C₆ is connected to an input of the first low pass filter Hi; an output of the first low pass filter H₁ is connected to an input of the eighth capacitor C₈; an output of the eighth capacitor C₈ is connected to an input of the wake-on-voice matching circuit 131; an input of the fifth capacitor C₅ is connected to an N signal input, and an output of the fifth capacitor C₅ is connected to an input of the fifth signal amplifier A₅; an output of the fifth signal amplifier A₅ is connected to an input of the seventh capacitor C₇7; an output of the seventh capacitor C₇ is connected to an input of the second low pass filter H₂ ; an output of the second low pass filter H₂ is connected to an input of the ninth capacitor C₉; an output of the ninth capacitor C₉ is connected to the input of the wake-on-voice matching circuit 131.

Herein, the P and N signal terminals of the microphone 10 acquires a positive voice signal and a negative voice signal respectively, the positive voice signal is denoted as MIC_P_RAW and the negative voice signal is denoted as MIC_N_RAW; firstly, the wake-on-voice preprocessing circuit isolates the switched MIC_P_RAW and MIC_N_RAW through the fourth capacitor C₄ and the fifth capacitor C₅ so that the wake-on-voice preprocessing circuit 130 and the data switching control circuit 121 have no interference on each other; then, the MIC_P_RAW and MIC_N_RAW subjected to isolation are amplified through the fourth amplifier A₄ and the fifth amplifier A₅ respectively for subsequent processing, herein the fourth amplifier A₄ and the fifth amplifier A₅ are analog amplifier, and their enlargement factors are set according to a range of amplitude of the ADC; the amplified voice signals are isolated through the sixth capacitor C₆ and the seventh capacitor C₇ so that there is no interference between front-stage and rear-stage circuits; low pass filtering is performed on the voice signals subjected to isolation by using a pair of low pass filters, i.e., a first low pass filter Hi and a second low pass filter H₂ so that only low-frequency signals are reserved, herein the filtering ranges of the first low pass filter H₁ and the second low pass filter H₂ are determined according to a range of frequency of voice template signals in the MCU and memory, and after filtering through the first low pass filter Hi and the second low pass filter H₂, voice signals having corresponding frequencies are obtained; the voice signals having corresponding frequencies are isolated through the eighth capacitor C₈ and the ninth capacitor C₉ so that there is no interference between the wake-on-voice preprocessing circuit 130 and the wake-on-voice matching circuit 131; finally, after the preprocessing is completed, the resulting positive voice signal MIC_P_RROCESSED and the resulting negative voice signal MIC_N_RROCESSED are obtained.

Specific structure and connection between various devices of the wake-on-voice matching circuit 131 is elaborated below with reference to FIG. 5.

As shown in FIG. 5, the wake-on-voice matching circuit 131 includes an analog-to-digital converter (ADC), a Micro Controller Unit (MCU) and a memory.

The connections between devices of the wake-on-voice matching circuit 131 are as follows.

An input of the ADC is connected an output of the wake-on-voice preprocessing circuit, an output of the ADC is connected to an input of the MCU, and the memory is connected to the input of the MCU.

Herein, the processed positive voice signal MIC_P_RROCESSED and the processed negative voice signal MIC_N_RROCESSED are input to the ADC for analog-to-digital conversion to obtain a digitalized voice signal that is input to the MCU, and the MCU compares the digitalized voice signal with multiple voice template signals stored in the memory, herein the multiple voice template signals are recorded in advance as criteria based on which voice matching is performed; if a degree of matching between the digitalized voice signal and one of the stored voice template signals is greater than a matching degree threshold, an interruption signal INT is transmitted to wake up the terminal; if degrees of matching between the digitalized voice signal and all of the stored voice template signals are smaller than the matching degree threshold, the processing is ended and the terminal keeps waiting.

For example, “Hello LUT” and “LUT Hello” are recorded in advance as criteria based on which voice matching is performed, “Hello LUT” is converted to digital voice signal 1010111010, “LUT Hello” is converted to digital voice signal 1101010101, an acquired digitalized voice signal is 1010111110, and the preset matching degree threshold is 80%; the digitalized voice signal 1010111110 is compared sequentially with the two criteria for voice matching, since a degree of matching between the digitalized signal 1010111010 and one of the criteria, 1010111110, is 90%, the matching succeeds and an INT signal is transmitted to wake up the terminal.

Herein, the matching degree threshold can be preset according to practical conditions, and generally, the matching degree threshold has a range of 70%-80%.

Herein, the analog-to-digital conversion includes sampling, quantifying and coding. And the sampling frequency is set according to a sampling rate at which voice template signals are digitalized subsequently in the MCU and the memory.

In the embodiment of the disclosure, based on the above circuit structure and connections between devices, the operation principle for wake-on-voice is as follows.

Firstly, the power supply switching control circuit 11 supplies the microphone 10 through the wake-on-voice power supply 14 when receiving an wake-on-voice instruction.

Then, the microphone 10 acquires a voice signal and inputs the voice signal to the data switching control circuit 12; the data switching control circuit 12 transmits the voice signal to the wake-on-voice circuit 13.

Finally, the wake-on-voice circuit 13 preprocesses and matches the input voice signal, and performs an operation according to a matching result.

Herein, the step that the wake-on-voice circuit 13 preprocesses and matches the voice signal and performs the operation according to the matching result includes:

firstly, the wake-on-voice preprocessing circuit 130 performs preprocessing operations such as amplification and low pass filtering on the voice signal, and inputs the preprocessed voice signal to the wake-on-voice matching circuit 131;

then, the wake-on-voice matching circuit 131 performs analog-to-digital conversion on the preprocessed voice signal to obtain a digitalized voice signal; the digitalized voice signal is compared with multiple stored voice template signals;

if a degree of matching between the digitalized voice signal and one of the stored voice template signals is greater than a matching degree threshold, the terminal is waken up;

if degrees of matching between the digitalized voice signal and all of the stored voice template signals are smaller than the matching degree threshold, the processing is ended.

According to the embodiments of the disclosure, the microphone 10, the wake-on-voice power supply 14, the wake-on-voice matching circuit 131, the terminal main control power supply 16, the terminal main control processing circuit 15 are built-in circuits of the terminal per se; with only one microphone provided in the terminal for being used in a time division multiplexing way, a wake-on-voice function and a normal voice function can both be implemented without following the existing wake-on-voice techniques in which an additional microphone is required to be dedicatedly arranged to acquire a wake-on-voice signal and thus it is required to design an audio circuit, a specific structure and an identification (ID) mechanism for the dedicatedly arranged microphone. In this way, the technical solutions according to embodiments of the disclosure can implement wake-on-voice with a simple and low-cost circuit structure.

Based on same technical ideas, an embodiment of the disclosure further provides a wake-on-voice method, since the principle of the method is similar to that of the current sampling circuit, for the implementation of the method and its principle, please refer to the implementation of the device and its corresponding principle, and duplicated content thereof will be omitted.

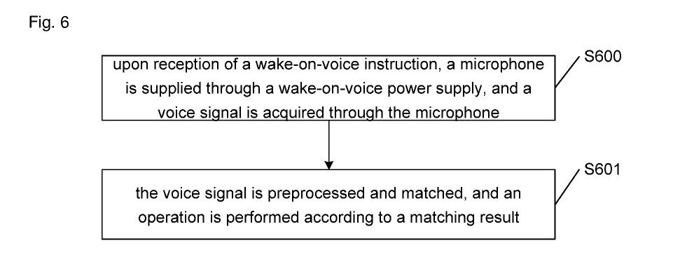

As shown in FIG. 6, the wake-on-voice method provided by the embodiment of the disclosure includes the following steps.

Step S600: upon reception of a wake-on-voice instruction, a microphone is supplied through a wake-on-voice power supply, and a voice signal is acquired through the microphone.

Herein, upon reception of the wake-on-voice instruction, the microphone is supplied through a wake-on-voice power supply, and then the microphone begins acquiring the voice signal.

Step S601: the voice signal is preprocessed and matched, and an operation is performed according to a matching result.

Specifically, the step that the voice signal is preprocessed includes: amplification and low pass filtering is performed on the voice signal to obtain the preprocessed voice signal.

Then, analog-to-digital conversion is performed on the preprocessed voice signal to obtain a digitalized voice signal.

The digitalized voice signal is compared with multiple stored voice template signals;

if a degree of matching between the digitalized voice signal and one of the stored voice template signals is greater than a matching degree threshold, the terminal is waken up;

if degrees of matching between the digitalized voice signal and all of the stored voice template signals are smaller than the matching degree threshold, the processing is ended.

Further, upon reception of an instruction indicating normal voice operation, the microphone is supplied through a terminal main control power supply; and

the voice signal is acquired through the microphone, and the voice signal is processed to perform the normal voice operation.

Although only preferable embodiments of the disclosure are described, once those skilled in the art know the basic inventive concept, they can make other modifications and changes to these embodiments.

Thus the accompanying claims are intended to include preferable embodiments and all changes and modifications within the scope of protection of the disclosure.

It is obvious that various changes and variations can be made by those skilled in the art without departing from the spirit and scope of the disclosure. In this way, if these modifications and variations fall within the scope of the claims and equivalent techniques, the disclosure is intended to include these changes and variations.

### INDUSTRIAL APPLICABILITY

In the wake-on-voice method and device provided by the embodiments of the disclosure, the microphone, the wake-on-voice power supply, the wake-on-voice matching circuit, the terminal main control power supply, the terminal main control processing circuit are built-in circuits of the terminal per se; with only one microphone provided in the terminal for being used in a time division multiplexing way, a wake-on-voice function and a normal voice function can both be implemented without following the existing wake-on-voice techniques in which an additional microphone is required to be dedicatedly arranged to acquire a wake-on-voice signal and thus it is required to design an audio circuit, a specific structure and an identification (ID) mechanism for the dedicatedly arranged microphone. In this way, the technical solutions according to embodiments of the disclosure can implement wake-on-voice with a simple and low-cost circuit structure.

1. A terminal, comprising a microphone, a power supply switching control circuit, a data switching control circuit, a wake-on-voice circuit, and a wake-on-voice power supply,
wherein the microphone is arranged to acquire a voice signal and input the voice signal to the data switching control circuit;
the power supply switching control circuit is arranged to, when receiving an wake-on-voice instruction, supply the microphone through the wake-on-voice power supply;
the data switching control circuit is arranged to, when receiving the wake-on-voice instruction, input the voice signal to the wake-on-voice circuit; and
the wake-on-voice circuit is arranged to preprocess and match the input voice signal, and perform an operation according to a matching result.

2. The terminal according to claim 1, wherein the wake-on-voice circuit comprises a wake-on-voice preprocessing circuit and a wake-on-voice matching circuit,
wherein the wake-on-voice preprocessing circuit is arranged to preprocess the input voice signal and input the preprocessed voice signal to the wake-on-voice matching circuit; and
the wake-on-voice matching circuit is arranged to match the preprocessed voice signal and perform the operation according to the matching result.

3. The terminal according to claim 1, further comprising a terminal main control processing circuit and a terminal main control power supply,
wherein the power supply switching control circuit is further arranged to, when receiving an instruction indicating normal voice operation, supply the microphone through the terminal main control power supply; and
the data switching control circuit is further arranged to, when receiving the instruction indicating normal voice operation, input the voice signal to the terminal main control processing circuit; and
the terminal main control processing circuit is arranged to process the input voice signal to perform the normal voice operation.

4. The terminal according to claim 3, wherein
the power supply switching control circuit is implemented by a first switching circuit comprising a first switch, a first capacitor, a first reference power supply and a first signal amplifier, the first switch comprising a Common (COM) terminal, a Normally Open (NO) terminal, a Normally Closed (NC) terminal, a control (CTR) terminal, a power supply terminal and a ground terminal; and/or
the data switching control circuit is implemented by a second switching circuit and a third switching circuit, wherein the second switching circuit comprises a second switch, a second capacitor, a second reference power supply and a second signal amplifier, the second switch comprising a COM terminal, an NO terminal , an NC terminal and a CTR terminal; and the third switching circuit comprises a third switch, a third capacitor, a third reference power supply and a third signal amplifier, the third switch comprising a COM terminal, an NO terminal, an NC terminal, a CTR terminal, a power supply terminal and a ground terminal.

5. The terminal according to claim 4, wherein
in the first switching circuit, the COM terminal of the first switch is connected to a COM terminal of a power supply of the microphone, the NC terminal of the first switch is connected to the wake-on-voice power supply, the NO terminal of the first switch is connected to the terminal main control power supply, the CTR terminal of the first switch is connected to an output of the first signal amplifier, the power supply terminal of the first switch is connected to the first reference power supply and to an end of the first capacitor, the ground terminal of the first switch is grounded, and the other end of the first capacitor is grounded;
in the second switching circuit, the COM terminal of the second switch is connected to a P signal terminal of the microphone, the NC terminal of the second switch is connected to a P signal input of the wake-on-voice circuit, the NO terminal of the second switch is connected to a P signal input of the terminal main control processing circuit, the CTR terminal of the second switch is connected to an output of the second signal amplifier, the power supply terminal of the second switch is connected to the second reference power supply and to an end of the second capacitor, the ground terminal of the second switch is grounded, and the other end of the second capacitor is grounded;
in the third switching circuit, the COM terminal of the third switch is connected to an N signal terminal of the microphone, the NC terminal of the third switch is connected to an N signal input of the wake-on-voice circuit, the NO terminal of the third switch is connected to an N signal input of the terminal main control processing circuit, the CTR terminal of the third switch is connected to an output of the third signal amplifier, the power supply terminal of the third switch is connected to the third reference power supply and to an end of the third capacitor, the ground terminal of the third switch is grounded, and the other end of the third capacitor is grounded.

6. The terminal according to claim 2, wherein
the wake-on-voice preprocessing circuit comprises a fourth capacitor, a fifth capacitor, a sixth capacitor, a seventh capacitor, an eighth capacitor, a ninth capacitor, a fourth signal amplifier, a fifth signal amplifier, a first low pass filter, a second low pass filter; and/or, the wake-on-voice matching circuit comprises an analog-to-digital converter (ADC), a Micro Controller Unit (MCU) and a memory.

7. The terminal according to claim 6, wherein
in the wake-on-voice preprocessing circuit, an input of the fourth capacitor is connected to a P signal input, an output of the fourth capacitor is connected to an input of the fourth signal amplifier; an output of the fourth signal amplifier is connected to an input of the sixth capacitor; an output of the sixth capacitor is connected to an input of the first low pass filter; an output of the first low pass filter is connected to an input of the eighth capacitor; an output of the eighth capacitor is connected to an input of the wake-on-voice matching circuit; an input of the fifth capacitor is connected to an N signal input, and an output of the fifth capacitor is connected to an input of the fifth signal amplifier; an output of the fifth signal amplifier is connected to an input of the seventh capacitor; an output of the seventh capacitor is connected to an input of the second low pass filter; an output of the second low pass filter is connected to an input of the ninth capacitor; an output of the ninth capacitor is connected to the input of the wake-on-voice matching circuit;
in the wake-on-voice matching circuit, an input of the ADC is connected an output of the wake-on-voice preprocessing circuit, an output of the ADC is connected to an input of the MCU, and the memory is connected to the input of the MCU.

8. A wake-on-voice method for a terminal, comprising:
upon reception of an wake-on-voice instruction, supplying a microphone through a wake-on-voice power supply, and acquiring a voice signal through the microphone;
preprocessing and matching the voice signal, and performing an operation according to a matching result.

9. The method according to claim 8, wherein the step of preprocessing and matching the voice signal and performing the operation according to the matching result comprises:
performing amplification and low pass filtering on the voice signal to obtain the preprocessed voice signal;
performing analog-to-digital conversion on the preprocessed voice signal to obtain a digitalized voice signal;
comparing the digitalized voice signal with a plurality of stored voice template signals;
if a degree of matching between the digitalized voice signal and one of the stored voice template signals is greater than a matching degree threshold, waking up the terminal;
if degrees of matching between the digitalized voice signal and all of the stored voice template signals are smaller than the matching degree threshold, ending the processing.

10. The method according to claim 8, further comprising:
upon reception of an instruction indicating normal voice operation, supplying the microphone through a terminal main control power supply; and
acquiring the voice signal through the microphone, and processing the voice signal to perform the normal voice operation.

11. The method according to claim 9, further comprising:
upon reception of an instruction indicating normal voice operation, supplying the microphone through a terminal main control power supply; and
acquiring the voice signal through the microphone, and processing the voice signal to perform the normal voice operation.
